(19) United States
(12) Patent Application Publication
(10) Pub. No.: US 2015/0246999 A1
(43) Pub. Date: Sep. 3, 2015

(54) ETHYLENEAMINE EPOXY HARDENER

(71) Applicant: DOW GLOBAL TECHNOLOGIES LLC, Midland, MI (US)

(72) Inventors: Rajesh Turakhia, Lake Jackson, TX (US); Ludovic Valette, Perrysburg, OH (US); Stephen W. King, League City, TX (US); Cecile Boyer, Lake Jackson, TX (US)

(21) Appl. No.: 14/432,780

(22) PCT Filed: Oct. 22, 2013
(86) PCT No.: PCT/US13/66181

§ 371 Date: Apr. 1, 2015

Related U.S. Application Data
(60) Provisional application No. 61/717,699, filed on Oct. 24, 2012.

(51) Int. Cl. C08G 59/50; C09J 163/00; C09D 163/00

(52) U.S. Cl. CPC C08G 59/5073; C09D 163/00; C09J 163/00

(57) ABSTRACT

A curable composition comprising a blend of: a) an epoxy resin; and b) a hardener comprising a polyfunctional amine is disclosed. The curable composition can be used in a variety of applications including, but not limited to coatings, civil engineering, flooring, composites, adhesives, and electrical laminates.

### BACKGROUND OF THE INVENTION

1. Field of the Invention

The present invention is related to epoxy resins. More particularly, the present invention is related to hardeners for epoxy resins.

2. Background of the Invention

Primary and secondary amines and their epoxy-adducts are the most widely used hardeners for epoxy resins. The selection of a hardener plays an important role in determining the final performance of the epoxy-amine thermoset. The ethyleneamine hardeners such as diethylenetriamine (DETA), triethylenetetraamine (TETA), tetraethylenepentamine (TEPA), and aminoethylpiperazine (AEP) when cured with epoxy resins, provide excellent reactivity and physical properties including excellent chemical and solvent resistance but are brittle and have limited flexibility and toughness. These ethyleneamines have poor compatibility with epoxy resins and will blush under humid conditions. Because of the incompatibility, they can exude to the surface during cure and react with atmospheric carbon dioxide and moisture to form undesirable carbamates also known as ‘blush’. These ethyleneamines are also hygroscopic, volatile, have high vapor pressure, and can cause rash and dermatitis if improperly handled.

Ethyleneamines have faster reactivity than other standard amines like polyetheramines, isophoronediamine, 1,2-diaminocyclohexane, 1,3-bisaminomethyl cyclohexane, and aromatic amines but shows incompatibility and provides blush when cured with epoxy resins. There is a need in the thermoset industry for ethyleneamine-type hardeners that have equal to or better reactivity than the standard ethyleneamines and their adducts, that have better compatibility with liquid epoxy resins (including aliphatic and aromatic epoxy resins), that have lower vapor pressure and that provide a thermoset with minimal blush.

### SUMMARY OF THE INVENTION

One broad aspect of the present invention is a curable composition comprising, consisting of, or consisting essentially of a blend of: a) an epoxy resin; and b) a hardener comprising a polyfunctional amine.

### BRIEF DESCRIPTION OF THE DRAWING

FIG. 1 is a time versus temperature graph showing the reactivity of various ethyleneamines.

### DETAILED DESCRIPTION OF THE INVENTION

### Epoxy Resin

Any suitable aromatic epoxy resin such as mono-, di-, tri-, poly-, glycidylether of bisphenol A or mono-, di-, tri-, poly-, glycidylether of bisphenol F can be used. Examples of epoxy resins include, but are not limited to liquid epoxy resins (LER) such as for example D.E.R.™ 383, D.E.R.™ 331, and D.E.R.™ 354, (‘D.E.R.’ is a trademark of The Dow Chemical Company). The epoxy resin can also be a epoxy resin blend comprising (i) an epoxy resin such as D.E.R.™ 383, or D.E.R.™ 331, or D.E.R.™ 354, and (ii) mono-, di-, tri-, and poly-glycidylethers of aliphatic epoxy resins, monoglycidylethers of aromatic epoxy resins, and iii) other reactive and non-reactive diluents. Examples of these are D.E.R.™ 736, D.E.R.™ 732, cresyl glycidyl ether, diglycidylether of aniline, alkyl (C₁₂-C₁₄) mono glycidyl ether 1,4-butanediol diglycidylether, 1,6-hexanediol diglycidyl ether, 2-ethylhexylglycidyl ether, neopentyl glycoldiglycidylether, trimethylolpropane triglycidyl ether, and hydrocarbon resins. Mixtures of two or more aromatic epoxy resins can also be used.

### Polyfunctional Amine

The amine compound useful as a hardener in the curable composition may include a polyamine compound comprising at least two cyclic rings that each have at least two amine groups separated from one another by a binary carbon spacing (C2 spacing) in each cyclic ring. In a preferred embodiment for example, the generic Formula I and II, set forth below, represent examples of the high molecular weight cyclic polyfunctional amine compounds useful in the present invention.

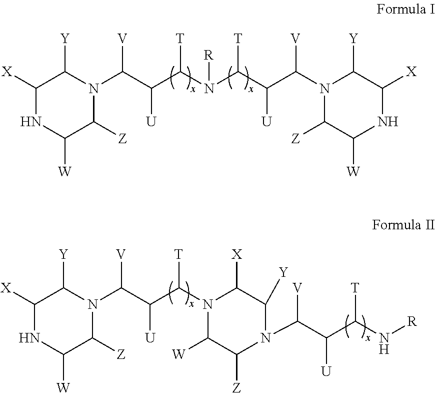

wherein each R, T, U, V, W, X, Y, and Z group, in Formula I and II above, is the same or different and is selected from hydrogen, or a hydrocarbyl group; and the value of x is 0 to 10, with the proviso that if x is greater than 1, each T may be the same or different.

Hydrocarbyl groups that may be used in the practice of the invention may be substituted or unsubstituted, linear, branched, or cyclic hydrocarbyl such as alkyl, aryl, aralkyl, or the like; a monovalent moiety including one or more heteroatoms; polyether chains comprising one or more oxyalkylene repeating units such as —R¹O—, wherein R¹ is often alkylene of 2 to 5 carbon atoms; other oligomeric or polymer chains of at least 2 repeating units. In an embodiment, R, T, U, V, W, X, Y, and Z are H or straight, branched, or cyclic hydrocarbyl such as alkyl of 1 to 10 carbon atoms, preferably 1 to 3 carbon atoms. In another embodiment, R, T, U, V, W, X, Y, and Z are H.

The values of x in the practice of the invention are typically in the range of from 1 to 10, preferably in the range of from 2 to 5, and more preferably in the range of from 2 to 3 and most preferably in the range of 0-1.

Examples of the high molecular weight, cyclic polyamines consistent with Formula I that are useful in the present invention include bis(2-(piperazin-1-yl)ethyl)amine (BPEA), (3-(piperazin-1-yl)propyl)amine, bis(4-(piperazin-1-yl)butyl)amine, bis(5-(piperazin-1-yl)pentyl)amine, bis(6-(piperazin-1-yl)hexyl)amine, bis(1-(piperazin-1-yl)propan-2-yl)amine, bis(2-(piperazin-1-yl)propyl)amine, and mixtures thereof.

Examples of the high molecular weight, cyclic polyamines consistent with Formula II that are useful in the present invention include 2-(4-(2-(piperazin-1-yl)ethyl)piperazin-1-yl)ethanamine, 3-(4-(3-(piperazin-1-yl)propyl)piperazin-1-yl)propan-1-amine, 4-(4-(4-(piperazin-1-yl)butyl)piperazin-1-yl)butan-1-amine, 5-(4-(5-(piperazin-1-yl)pentyl)piperazin-1-yl)pentan-1-amine, 6-(4-(6-(piperazin-1-yl)hexyl)piperazin-1-yl)hexan-1-amine, 1-(4-(1-(piperazin-1-yl)propan-2-yl)piperazin-1-yl)propan-2-amine, 2-(4-(2-(piperazin-1-yl)propyl)piperazin-1-yl)propan-1-amine, and mixtures thereof.

One preferred embodiment of the cyclic polyamine compound useful in preparing the composition of the present invention includes for example bis(2-(piperazin-1-yl)ethyl)amine (BPEA); 2-(4-(2-(piperazin-1-yl)ethyl)piperazin-1-yl)ethanamine; high molecular weight BPEA oligomers; and mixtures thereof.

### Optional Components

### Additional Hardener

In an embodiment, additional hardeners along with the polyfunctional amine can be used in the curable composition. Examples of additional hardeners that can be used include, but are not limited to aliphatic amines, modified aliphatic amines, cycloaliphatic amines, modified cycloaliphatic amines, amidoamines, polyamide, tertiary amines, aromatic amines, and the like. Suitable hardeners include Bis(4-aminocyclohexyl)methane (AMICURE® PACM), aminoethylpiperazine (AEP), isophorone diamine (IPDA), 1,2-diaminocyclohexane (DACH), 4,4′-diaminodiphenylmethane (MDA), 4,4′-diaminodiphenylsulfone (DDS), m-phenylenediamine (MPD), diethyltoluenediamine (DETDA), metda-xylene diamine (MXDA), and 1,3-bis(aminomethyl)cyclohexane (1,3-BAC).

### Catalyst

Optionally, catalysts may be added to the curable compositions described above. Catalysts may include but not limited to salicylic acid, bisphenol A, 2,4,6,-tris(dimethylaminomethyl)phenol (DMP-30), and phenol derivatives.

In addition to the above optional compounds that may be added to the curable composition of the present invention, other optional compounds useful in the curable composition may include, for example, a solvent to lower the viscosity of the composition further or accelerate the curing reaction; other resins such as a phenolic resin that can be blended with the epoxy resin of the composition; other epoxy resins different from the at least one thermosetting epoxy resin compound, component (ii), of the present invention (for example, aromatic and aliphatic glycidyl ethers; cycloaliphatic epoxy resins; and divinylarene dioxides such as divinylbenzene dioxide); fillers including for example finely divided minerals such as silica, alumina, zirconia, talc, sulfates, TiO₂, carbon black, graphite, silicates, and the like; colorants including pigments, dyes, tints, and the like; toughening agents; accelerators; flow modifiers; adhesion promoters; diluents; stabilizers such as UV stabilizers; plasticizers; catalyst de-activators; flame retardants; reinforcing agents; rheology modifiers; surfactants; antioxidants; wetting agents; and mixtures thereof.

### Process for Producing the Composition

In an embodiment, the curable composition can be prepared by admixing a) an epoxy resin and b) hardener comprising the polyfunctional amine described above. In an embodiment, any of the optional components described above can be added to the admixture. The admixing can be done in any order, and in any combination or sub-combination.

Epoxy resins are formulated with the polyfunctional amine at an epoxide to amine hydrogen equivalent ratio in the range of from 0.7 to 1.3 in an embodiment, from 0.9 to 1.1 in another embodiment, and from 0.95 to 1.05 in yet another embodiment.

In an embodiment, the composition is cured at a temperature in the range of from 0° C. to 200° C.

### End Use Applications

The curable composition of the present invention can be used in a variety of applications including, but not limited to coatings, civil engineering, flooring, composites, adhesives, and electrical laminates.

### EXAMPLES

D.E.R.™ 324—aliphatic glycidyl ether, reactive diluent modified liquid epoxy resin, available from the Dow Chemical Company

D.E.H.™ 20—diethylenetriamine (DETA) hardener available from the Dow Chemical Company

D.E.H.™ 24—triethylenetetramine (TETA) hardener available from the Dow Chemical Company

D.E.H.™ 26—tetraethylenepentamine (TEPA) hardener available from the Dow Chemical Company

D.E.H.™ 39—aminoethylpiperazine (AEP) hardener available from the Dow Chemical Company

BPEA—bis(2-(piperazin-1-yl)ethyl)amine

### Vapor Pressure

A comparison of vapor pressure at 25° C. for various ethyleneamines (source=PPDS, Antoine equation predictions) is shown in Table 1. Vapor pressure data were measured in an ebulliometer using ASTM method E1719. The principle of the method consists of measuring the boiling temperature of each material at equilibrium at preset pressures between 5 and 300 mmHg. By definition, the vapor pressure of a liquid at its boiling point equals the pressure of its surrounding environment. The obtained equilibrium vapor pressure-temperature data were then correlated to the Antoine equation LogP=A−B/(T+C) where P is the vapor pressure, T the boiling temperature, to determine the A, B, and C Antoine equation parameters specific for the material in question. Inputting the obtained A, B, C constants in the Antoine equation yields the vapor pressure prediction at the desired temperature, as is shown in Table 1 at 25° C.”

BPEA has the lowest vapor pressure and highest molecular weight among all of the ethyleneamines listed in Table 1. The combination of high molecular weight and the low vapor pressure improves the compatibility with epoxy resins.

TABLE 1
Vapor Pressure and Molecular Weight

| | Vapor Pressure | Vapor Pressure | Molecular Weight |
|---|---|---|---|
| Ethyleneamines | 25° C./mm Hg | 25° C./mbar | Daltons |
| Ethylenediamine | 1.29E+01 | 1.72E+01 | 60.1 |
| D.E.H. 20 (DETA) | 1.40+E−01 | 1.90E−01 | 103.2 |
| D.E.H. 24 (TETA) | 2.97E−03 | 4.00E−03 | 146.2 |
| D.E.H. 27 (TEPA) | 4.36E−05 | 5.80E−05 | 189.3 |
| D.E.H. 39 (AEP) | 7.87E−02 | 1.05E−01 | 129.2 |
| Piperazine | 3.24E+00 | 4.31E+00 | 86.1 |
| BPEA | 1.24E−05 | 1.65E−05 | 241.2 |

Table 2 provides the Amine Hydrogen Equivalent Weight (AHEW) Comparison of Various Ethyleneamines

TABLE 2
Amine Hydrogen Equivalent Weight

| | Amine Hydrogen |
|---|---|
| Ethyleneamines | Equivalent Weight |
| D.E.H. 20 (DETA) | 20 |
| D.E.H. 24 (TETA) | 24 |
| D.E.H. 26 (TETA) | 27 |
| D.E.H. 39 (AEP) | 43 |
| BPEA | 80 |

As shown in Table 2, BPEA has a unique amine hydrogen equivalent weight of 80 which is much different and higher than the standard ethyleneamines which are in the range of 20 to 45. This unique amine hydrogen equivalent weight provides formulators with more options to develop new thermoset formulations based on epoxy resins and amine hardeners.

### Blush Resistance and Compatibility with Epoxy Resins

A stoichiometric amount of D.E.R.™ 331 was mixed with DETA, AEP, and BPEA. A 10 mil thick coating was draw-down on a steel panel. The coating was cured for 24 hours at room temperature. As shown in Table 3, the film based on BPEA had no blush and had good appearance indicating its excellent compatibility with standard liquid epoxy resins. It is very common for ethyleneamines like DETA and AEP to have blush on the film when cured with standard liquid epoxy resins.

TABLE 3
Blush Properties

| | Formulation 1 | Formulation 2 | Formulation 3 |
|---|---|---|---|
| | Weight (grams) | Weight (grams) | Weight (grams) |
| D.E.R. ™ 331 Epoxy | 7 | 8.13 | 8.99 |
| Resin | | | |
| D.E.H.* 20 (DETA) | — | — | 1.01 |
| D.E.H.* 39 (AEP) | — | 1.87 | — |
| BPEA | 3 | — | — |
| 24 hr Room Temp | | | |
| Cure | | | |
| Blush | No | Yes | Yes |
| Appearance | Good | Average | Poor |

### Exotherm Test

The epoxy resin and amine were kept in a room where the temperature was maintained at 25° C. for 24 h. The epoxy and amine mixture of 100 grams were added to a 180 mL plastic cup and mixed well for a minute using a spatula. The cup was closed with a polypropylene lid and a thermocouple was inserted through the hole in the middle of the lid. The other end of the thermocouple was connected to a digital data recorder. The temperature was recorded in 1 minute intervals. The saved data was transferred to an Excel spreadsheet and plotted to get the exotherm profile.

Formulations were prepared for an exotherm test. The details of the formulations are given in Table 4, below.

TABLE 4
Formulation Details for Exotherm Test

| | Formu- | Formu- | Formu- | Formu- | Formu- |
|---|---|---|---|---|---|
| | lation 1 | lation 2 | lation 3 | lation 4 | lation 5 |
| Resin and | (weigth | (weigth | (weigth | (weigth | (weigth |
| Hardeners | %) | %) | %) | %) | %) |
| D.E.R. 324 | 90.6 | 89.1 | 88.1 | 82.3 | 71.3 |
| D.E.H. 20 | 9.4 | | | | |
| (DETA) | | | | | |
| D.E.H. 24 | | 10.9 | | | |
| (TETA) | | | | | |
| D.E.H. 26 | | | 11.9 | | |
| (TEPA) | | | | | |
| D.E.H. 39 | | | | 17.7 | |
| (AEP | | | | | |
| BPEA | | | | | 28.7 |

The results of the exotherm test are shown in Table 5, below.

TABLE 5
Exotherm Results Summary

| | | Peak Exotherm | Peak Exotherm |
|---|---|---|---|
| | | Temperature | Time |
| Formulation | Formulation | (° C.) | (min) |
| DER 324/DEH 20 | Formulation 1 | 227 | 62 |
| DER 324/DEH 24 | Formulation 2 | 204 | 66 |
| DER 324/DEH 26 | Formulation 3 | 200 | 69 |
| DER 324/DEH 39 | Formulation 4 | 218 | 37 |
| DER 324/BPEA | Formulation 5 | 197 | 38 |

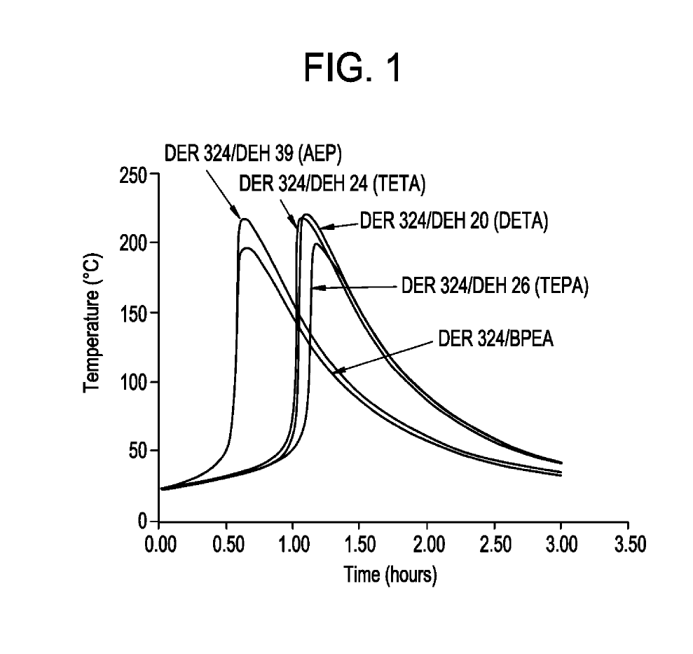

Ethyleneamines are one of the fastest hardeners when cured with epoxy resins. The exotherm results in Table 5 clearly indicate that BPEA is as fast as AEP (D.E.H.™ 39) which is the one of the fastest reacting ethyleneamines. A graphical depiction of the reactivity of these ethyleneamines is shown in FIG. 1.

### Mechanical Properties

Tensile and Flexural tests were done based on ASTM D638 and ASTM D790. Clear castings were made based on D.E.R. 353 epoxy resin and the individual ethyleneamines as shown in Table 6. The thermal and mechanical properties are shown in Table 7. BPEA has a cyclic structure similar to AEP and as shown in Table 7 its mechanical properties are very similar to AEP.

TABLE 6
Formulations for Mechanical Properties

| | Formu- | Formu- | Formu- | Formu- |
|---|---|---|---|---|
| Resins and | lation 1 | lation 2 | lation 3 | lation 4 |
| Hardeners | (weight %) | (weight %) | (weight %) | (weight %) |
| D.E.R. 353 | 71 | 90.7 | 82 | 89 |
| D.E.H. 20 | — | 9.3 | — | — |
| (DETA) | | | | |
| D.E.H. 24 | — | — | — | 11 |
| (TETA) | | | | |
| D.E.H. 39 | — | — | 18 | — |
| (AEP) | | | | |
| BPEA | 29 | — | — | — |

TABLE 7
Thermal and Mechanical Properties

| | Formu- | Formu- | Formu- | Formu- |
|---|---|---|---|---|
| Properties | lation 1 | lation 2 | lation 3 | lation 4 |
| Tensile Modulus | 3.3 ± 0.1 | 3.3 ± 0.1 | 3.3 ± 0.2 | 3.2 ± 0.1 |
| (GPa) | | | | |
| Tensile Strength | 34 ± 5 | 70 ± 0.5 | 40 ± 6 | 69 ± 1 |
| (MPa) | | | | |
| Elongation at | 1.3 ± 0.25 | 3.9 ± 0.1 | 1.3 ± 0.3 | 3.6 ± 0.4 |
| Break (%) | | | | |
| Flexural Modulus | 3.1 ± 0.2 | 3.1 ± 0.1 | 3.3 ± 0.1 | 3.2 ± 0.1 |
| (Gpa) | | | | |
| Flexural Strength | 76 ± 5 | 100 ± 0.01 | 68 ± 1 | 103 ± 0.01 |
| (MPa) | | | | |
| Tg (° C.) | 67 | 78 | 75 | 77 |

1. A curable composition comprising a blend of:
a) an epoxy resin; and
b) a hardener comprising a polyfunctional amine having the formula 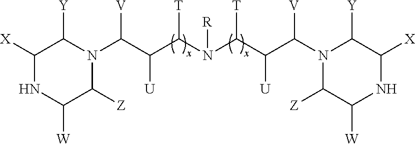
wherein each R, T, U, V, W, X, Y, and Z group is the same or different and is selected from hydrogen or a hydrocarbyl group; and the value of x is 0 to 10, with the proviso that if x is greater than 1, each T may be the same or different.

2. A curable composition in accordance with claim 1 wherein said polyfunctional amine has the formula 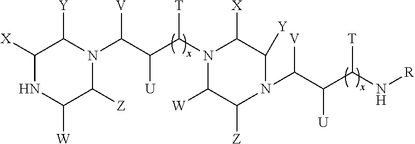
wherein each R, T, U, V, W, X, Y, and Z group is the same or different and is selected from hydrogen or a hydrocarbyl group; and the value of x is 0 to 10, with the proviso that if x is greater than 1, each T may be the same or different.

3. A curable composition in accordance with claim 1 wherein said polyfunctional amine is bis(2-(piperazin-1-yl)ethyl)amine.

4. A curable composition in accordance with claim 1 further comprising a hardener other than said polyfunctional amine.

5. A curable composition in accordance with claim 1 wherein the epoxy resin is selected from the group consisting of aromatic epoxy resins and aliphatic epoxy resins.

6. A curable composition in accordance with claim 1 having an epoxy to amine hydrogen equivalent weight ratio is in the range of from 0.7 to 1.3.

7. A curable composition in accordance with claim 1 further comprising a catalyst.

8. A curable composition in accordance with claim 7 wherein the catalyst is present in an amount in the range of from 5 weight percent to 1 weight percent, based on the total weight of the composition.

9. A process for preparing a curable composition comprising admixing a) an epoxy resin and b) hardener comprising the polyfunctional amine of claim 1.

10. A process for preparing a thermoset comprising curing the curable composition of claim 1.

11. A process in accordance with claim 10, wherein said curing is carried out at a temperature in the range of from 0° C. to 200° C.

12. An article prepared from the curable composition of claim 1.

13. An article in accordance with claim 12, wherein the article is selected from the group consisting of a coating, a composite, an adhesive, and an electrical laminate.
